(19) United States
(12) Patent Application Publication
(10) Pub. No.: US 2024/0193371 A1
(43) Pub. Date: Jun. 13, 2024

(54) AVERTING DISCORD BY ALIGNING CHAT

(71) Applicant: INTERNATIONAL BUSINESS MACHINES CORPORATION, ARMONK, NY (US)

(72) Inventors: Kelley Anders, East New Market, MD (US); Jonathan D. Dunne, Dungarvan (IE)

(21) Appl. No.: 18/062,594

(22) Filed: Dec. 7, 2022

(51) Int. Cl. G06F 40/35; G06F 40/166; G06F 40/20; H04L 51/216

(52) U.S. Cl. CPC G06F 40/35; G06F 40/166; G06F 40/20; H04L 51/216

(57) ABSTRACT

According to one embodiment, a method, computer system, and computer program product for explaining discourse is provided. The embodiment may include monitoring a conversation. The embodiment may also include deriving a conversation alignment model based on the conversation. The embodiment may further include identifying a misalignment in the conversation. The embodiment may also include taking an action to align the conversation based on the conversation alignment model.

### BACKGROUND

The present invention relates generally to the field of computing, and more particularly to natural language processing.

Natural language processing is a field of computing that enables computers to process, translate, and practically understand natural language. As opposed to languages and formats designed or encoded for computers to understand, such as programming languages, markup languages, and databases, natural language is the type ordinarily used for communication between humans, and thus requires computing techniques such as lexical analysis artificial intelligence and machine learning to process. However, these methods enable computers to simplify user interfaces and interact with text not written specifically for computers to interact with.

### SUMMARY

According to one embodiment, a method, computer system, and computer program product for explaining discourse is provided. The embodiment may include monitoring a conversation. The embodiment may also include deriving a conversation alignment model based on the conversation. The embodiment may further include identifying a misalignment in the conversation. The embodiment may also include taking an action to align the conversation based on the conversation alignment model.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates an exemplary networked computer environment according to at least one embodiment.

FIG. 2 illustrates an operational flowchart for a process for averting discord by aligning a conversation.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may, however, be embodied in many different forms and should not be construed as limited to the exemplary embodiments set forth herein. In the description, details of well-known features and techniques may be omitted to avoid unnecessarily obscuring the presented embodiments.

It is to be understood that the singular forms “a,” “an,” and “the” include plural referents unless the context clearly dictates otherwise. Thus, for example, reference to “a component surface” includes reference to one or more of such surfaces unless the context clearly dictates otherwise.

Embodiments of the present invention relate to the field of computing, and more particularly to natural language processing. The following described exemplary embodiments provide a system, method, and program product to, among other things, explain discourse to users with various skill levels. Therefore, the present embodiment has the capacity to improve the technical field of natural language processing by assessing explainability of complex discourse to aide user understanding based on user skill level.

As previously described, natural language processing is a field of computing that enables computers to process, translate, and practically understand natural language. As opposed to languages and formats designed or encoded for computers to understand, such as programming languages, markup languages, and databases, natural language is the type ordinarily used for communication between humans, and thus requires computing techniques such as lexical analysis, artificial intelligence and machine learning to process. However, these methods enable computers to simplify user interfaces and interact with text not written specifically for computers to interact with.

Natural language processing may be useful in the context of a conversation, helping moderate a public forum, social network, or chat service. However, while current solutions may use simple methods of lexical analysis to, for example, superficially moderate a web forum, these solutions function post-hoc, attempting to address full-blown arguments after they are already in progress. Furthermore, users can often speak past each other, allowing misunderstandings to develop and grow deeper over time. As such, it may be advantageous to engage in analysis of an alignment level, where misalignments include discordances, misunderstandings, disturbances, and arguments, and restore alignment or avert deeper misalignments.

According to one embodiment, a method for averting discord by aligning a conversation is provided. The method may involve monitoring a conversation for misalignments, such as a misunderstanding or disturbance. A chat alignment model may be derived from the content of the conversation. The model may then be used to identify a misalignment or potential misalignment. Finally, the method may involve taking an action to bring the chat back into alignment, such as recommending that a user rephrase a message or providing a user with an explanation.

Any advantages listed herein are only examples and are not intended to be limiting to the illustrative embodiments. Additional or different advantages may be realized by specific illustrative embodiments. Furthermore, a particular illustrative embodiment may have some, all, or none of the advantages listed above.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

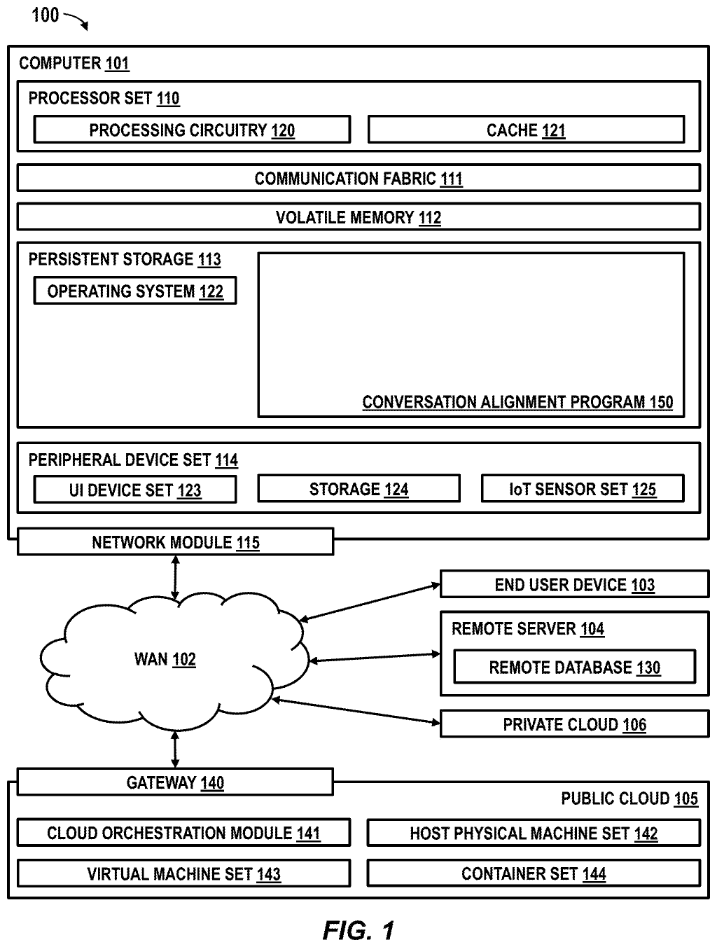

Referring now to FIG. 1, computing environment 100 contains an example of an environment for the execution of at least some of the computer code involved in performing the inventive methods, such as conversation alignment program 150. In addition to conversation alignment program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and conversation alignment program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed conversation is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in conversation alignment program 150 in persistent storage 113.

Communication fabric 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in conversation alignment program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN 102 and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community, or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

The conversation alignment program 150 may monitor a conversation for misalignment, discord, conflict or misunderstanding. The conversation may then be used to derive a chat alignment model. The conversation alignment program 150 may use the model to identify a misalignment or potential misalignment. Upon identifying a misalignment or potential misalignment, the conversation alignment program 150 may take an action to bring the chat back into alignment or avert further misalignment, such as recommending that a user rephrase a message or providing a user with an explanation.

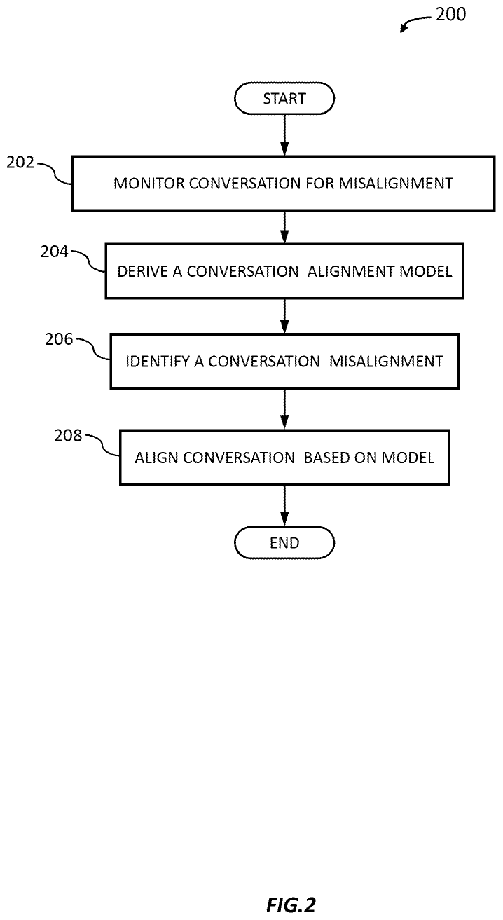

Furthermore, notwithstanding depiction in computer 101, conversation alignment program 150 may be stored in and/or executed by, individually or in any combination, end user device 103, remote server 104, public cloud 105, and private cloud 106. The discourse explanation method is explained in more detail below with respect to FIG. 2.

Referring now to FIG. 2, an operational flowchart for a process for averting discord by aligning a conversation 200 is depicted according to at least one embodiment. At 202, the conversation alignment program 150 monitors a conversation for misalignment. A conversation may be, for example, a chat between two or more users, a web forum thread, a thread on a social media service or a microblogging service, a discussion on a blog with comments, an email thread, or a larger collection of chat rooms or threads. Misalignment may include misunderstanding, discord, or conflict among two or more users, or any other failure of the users to engage in a meeting of the minds. Monitoring a conversation may include collecting data about messages, posts, users, and the medium in which the conversation occurs, including metadata.

Misalignment may include a state of misunderstanding, discord, or conflict among two or more users. Misalignment may be thought of as a state of conversation where two users are communicating in a manner where there is not a “meeting of the minds,” or are “talking past each other.” For example, misalignment may include a chat room where several users are using the word “star” to refer to a celestial body, and other users are using the word “star” to refer to a celebrity. As another example, misalignment may include a scenario where an argument is beginning to form around a minor disagreement about a minor issue of taste.

In at least one embodiment, monitoring misalignment may include identifying a level of misalignment, measured by a numerical value, by distinct levels, or a binary value. A numerical value may include an integer, rational number, or real number, including a percentage or a ratio, representing a degree of alignment or misalignment. A binary value may represent whether a conversation is aligned or misaligned, or whether alignment or misalignment exceeds a certain threshold. Distinct levels may include, for example, “level A,” “level B,” and “level C,” or “full alignment,” “potential misalignment,” “imminent misalignment,” and “current misalignment.” A level of misalignment may be determined based on analyzed data as described below.

Alternatively, monitoring misalignment may include identifying a type or source of misalignment. For example, types of misalignment may include “misunderstanding,” “discord,” “conflict,” and “argument.” Sources of misalignment may include a particular message, post, conversation, or user.

A conversation may be, for example, a chat or call between two or more users, or an email thread. Alternatively, a conversation may be a web forum thread, a thread on a social media service or microblogging service, a discussion on a blog with comments, or a similar service with posts and comments. Posts and comments may each consist of text, images, video, or audio. As another alternative, a conversation may be a larger collection of chat rooms or threads, such as a whole forum, a subforum, a group of chatrooms, or a group that includes multiple media of conversation.

A conversation may be a synchronous conversation such as a chat or video call where users are interacting with one another concurrently, live, or in real time. Alternatively, a conversation may be an asynchronous conversation, such as a web forum or an email thread where users tend to interact on their own time, or one by one.

In another embodiment, monitoring a conversation may further include collecting data. Data may include, for example, data about a conversation, data about users, metadata, data collected for machine learning, or analyzed data.

Data and metadata about a conversation may include data about messages and posts. Such data may include the content of such messages and posts, including text, images, videos, audio, other attachments, URIs, and any other information included in messages or posts. Metadata about a message or post may include a time at which or place or device from which the message or post is sent or posted, a size or length of the post or message, or a topic of the post or message. A topic may be represented by a hashtag, by a forum or subforum in which a post is posted, or a topic of a chat room in which a message is sent.

In an alternative embodiment, data and metadata about a conversation may include data collected according to opt-in procedures about messages that are not sent, or posts that are not posted, or versions or drafts of messages that are sent or posts that are posted. Such data may be collected continuously or at any practical frequency.

Data and metadata about users may be collected according to opt-in procedures, and may include, for example, a user's preferred language, a user's location, the full set of content the user has shared, information about the user's preferences, a user's date of birth, a time at which a user joined a service or a conversation, a user's most engaged topics, or a frequency with which a user engages in the conversation.

Data collected for machine learning may include feedback collected based on actions taken at 208. For example, if the conversation alignment program 150 successfully averts misunderstanding by recommending a resource to a user, a user interface may ask a user if the resource was helpful in resolving the misunderstanding, with an option for “yes,” and “no,” or with a Universal Resource Indicator (URI) leading to a longer feedback form. Alternatively, data collected for machine learning may include alignment levels before and after a given action is taken.

Collecting data may further include analyzing data to create analyzed data. Analyzing data may include using topic modeling, corpus linguistics, Latent Dirichlet Allocation (LDA), word to vector, Jacquard Distance, natural language understanding (NLU), IBM Watson® Natural Language Understanding services (IBM Watson and all IBM Watson-based trademarks and logos are trademarks or registered trademarks of International Business Machines Corporation and/or its affiliates), Cohen's Kappa scores, or a combination or average of more than one piece of analyzed data. For example, analyzed data may include an average of distances found using multiple techniques. Data analysis may be performed using artificial intelligence, and may be used to perform machine learning, or in conjunction with a neural network. Analyzed data may be used to determine a level of misalignment as described above.

A conversation may be monitored in real time, or substantially in real time, quickly enough that action may be taken at step 208, or quickly enough to avert deeper misalignment, even for synchronous conversations. Alternatively, a conversation may be monitored after the fact, such as for the purpose of machine learning, or less quickly, for the purpose of supporting asynchronous conversations.

Then, at 204, the conversation alignment program 150 derives or trains one or more conversation alignment models. A conversation alignment model may be formed based on analyzed data or other data collected at 202. The conversation alignment program 150 may derive one model per user, per chat, per group, per team, or per organization, or generally across a network, or in any other combination. The conversation alignment program 150 may generalize or combine multiple models into one higher-order model.

In at least one embodiment, the conversation alignment model may be derived from or trained based on the content of messages, analyzed data, feedback, or any other data collected at 202. The conversation alignment model may be trained using any variety of machine learning methods, including artificial neural networks and the data analysis methods described above.

The conversation alignment program 150 may derive multiple models, including models per user, per chat, per group, per team, or per organization. The conversation alignment program 150 may further derive one model generally across a network, or any combination of higher- and lower-order models. In an alternative embodiment, the conversation alignment program 150 may combine multiple models using techniques such as federated learning. For example, if one model is derived per organization, several organizations may engage in federated learning to derive a higher-order model.

Next, at 206, the conversation alignment program 150 identifies a misalignment in the conversation. Identifying a misalignment may include predicting a potential misalignment, identifying a misalignment that is just beginning, or identifying a misalignment in progress. A misalignment may include one message that may cause or represent a state of misalignment, a misalignment level exceeding a certain threshold, a particular type of misalignment, or a state of misalignment as identified by the conversation alignment model.

Predicting a potential misalignment may be performed using the conversation alignment model, the analyzed data, or the alignment level determined at 202. For example, if a topic of conversation relates to quantum physics, and the model suggests that Alice understands quantum physics at a much higher level than Bob, the conversation alignment program 150 may determine that the conversation is 15% likely to involve a misunderstanding when Alice is present but Bob is not, and 60% likely to involve a misunderstanding after Bob joins. Alternatively, the conversation alignment program 150 may determine that, when Charlie and David engage in a conversation that mentions their favorite sports teams, they are likely to engage in an argument within six messages.

Then, at 208, the conversation alignment program 150 takes an action to align the conversation based on the conversation alignment model. Aligning the conversation may include taking action to mitigate or prevent future misalignment or bring a conversation back towards alignment, such as by removing the cause of the misalignment or redirecting the conversation towards alignment. An action may include a recommendation to a user or moderator or a direct action taken automatically.

In at least one embodiment, an action may include a recommendation to a user. For example, a recommendation may include recommending that a user rephrase or modify a message before or after sending the message, which may display similarly to a spell-checking service, such as by a red underline under words that should be changed in a message editor. As another example, a recommendation may include suggesting that a user take a break from a social media service for an hour or the rest of the day. Alternatively, a recommendation may be to add a particular user to a conversation, where the particular user is an expert on the topic of conversation, a good mediator, or a mutual friend of two users who might argue.

As yet another example, a recommendation on a web forum may provide a resource to a user, such as a link that will help the user understand the topic of conversation to avert a potential misunderstanding. If a topic of conversation relates to quantum physics, and the model suggests that Alice understands quantum physics at a much higher level than Bob, and Bob replies to a post by Alice in the conversation dealing specifically with quantum entanglement, a resource may be selected to help Bob understand quantum entanglement better. A resource may be, for example, a link to a website, an explanation in a database, or a service that provides explanations.

In another embodiment, a recommendation may be made to a moderator or administrative user. For example, the conversation alignment program 150 may recommend that a moderator temporarily mute, suspend, or ban a user who is causing a disturbance that leads to misalignment. Alternatively, a recommendation may be that a moderator hide or remove a post or comment that is causing a high degree of misalignment.

In yet another embodiment, the conversation alignment program 150 may take direct action automatically, or direct another program to take action automatically. For example, the conversation alignment program 150 may make an automatic correction to a message or post in a context where the correction will help align the conversation or avert misalignment. Alternatively, the conversation alignment program 150 may ban a user from a conversation, or add another user to the conversation, such as an expert on the topic of conversation, a good mediator, or a mutual friend of two users who might otherwise argue.

In addition to using the conversation alignment model, the conversation alignment program 150 may make relevant determinations using the conversation analysis methods from 202 or other methods of artificial intelligence.

The conversation alignment program 150 may select the type of action, the particular action taken, and other actions based on the conversation alignment model and other factors. For example, the conversation alignment program 150 may determine, using the conversation alignment model, that some users are more open to suggestions than other users, and make suggestions to open-minded users first, and closed-minded users afterwards. Alternatively, a moderator for a web forum may change settings for the actions the conversation alignment program 150 may take to align a conversation. For example, a moderator may set a low threshold requirement for muting a user for fifteen minutes, but set a high threshold requirement for suspending a user for more than a day, or disable the conversation alignment program 150 from banning a user permanently.

The conversation alignment program 150 may select an action to maximize the average likely alignment level, minimize the risk that alignment sinks below a certain threshold, or minimize a certain form of misalignment, such as a degree of argument-type misalignment. The conversation alignment program 150 may further predict the likely effects of a given action, and determine an action to minimize other negative effects. For example, the conversation alignment program 150 may determine that, while banning Erin may reduce the likelihood of a misalignment today, Erin is usually helpful in maintaining alignment, and banning Erin may have negative long-term consequences.

It may be appreciated that FIG. 2 provides only an illustration of one implementation and does not imply any limitations with regard to how different embodiments may be implemented. Many modifications to the depicted environments may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method, the method comprising:
monitoring a conversation;
deriving a conversation alignment model based on the conversation;
identifying a misalignment in the conversation; and
taking an action to align the conversation based on the conversation alignment model.

2. The method of claim 1, wherein the conversation is a synchronous conversation.

3. The method of claim 1, wherein monitoring the conversation includes creating analyzed data based on analyzing the conversation using natural language processing.

4. The method of claim 1, wherein the conversation includes two or more users, and one user conversation alignment model is derived per user from the two or more users.

5. The method of claim 1, further comprising:
deriving two or more lower conversation alignment models; and
deriving a higher conversation alignment model from the two or more lower conversation alignment models using federated learning.

6. The method of claim 1, wherein the action includes providing a resource to a user to explain a topic of the conversation.

7. The method of claim 1, wherein the action includes automatically modifying a message or post.

8. A computer system, the computer system comprising:
one or more processors, one or more computer-readable memories, one or more computer-readable tangible storage medium, and program instructions stored on at least one of the one or more tangible storage medium for execution by at least one of the one or more processors via at least one of the one or more memories, wherein the computer system is capable of performing a method comprising:
monitoring a conversation;
deriving a conversation alignment model based on the conversation;
identifying a misalignment in the conversation; and
taking an action to align the conversation based on the conversation alignment model.

9. The computer system of claim 8, wherein the conversation is a synchronous conversation.

10. The computer system of claim 8, wherein monitoring the conversation includes creating analyzed data based on analyzing the conversation using natural language processing.

11. The computer system of claim 8, wherein the conversation includes two or more users, and one user conversation alignment model is derived per user from the two or more users.

12. The computer system of claim 8, further comprising:
deriving two or more lower conversation alignment models; and
deriving a higher conversation alignment model from the two or more lower conversation alignment models using federated learning.

13. The computer system of claim 8, wherein the action includes providing a resource to a user to explain a topic of the conversation.

14. The computer system of claim 8, wherein the action includes automatically modifying a message or post.

15. A computer program product, the computer program product comprising:
one or more computer-readable tangible storage medium and program instructions stored on at least one of the one or more tangible storage medium, the program instructions executable by a processor capable of performing a method, the method comprising:
monitoring a conversation;
deriving a conversation alignment model based on the conversation;
identifying a misalignment in the conversation; and
taking an action to align the conversation based on the conversation alignment model.

16. The computer program product of claim 15, wherein the conversation is a synchronous conversation.

17. The computer program product of claim 15, wherein monitoring the conversation includes creating analyzed data based on analyzing the conversation using natural language processing.

18. The computer program product of claim 15, wherein the conversation includes two or more users, and one user conversation alignment model is derived per user from the two or more users.

19. The computer program product of claim 15, further comprising:
deriving two or more lower conversation alignment models; and
deriving a higher conversation alignment model from the two or more lower conversation alignment models using federated learning.

20. The computer program product of claim 15, wherein the action includes providing a resource to a user to explain a topic of the conversation.
